(19) United States
(12) Patent Application Publication
(10) Pub. No.: US 2012/0326003 A1
(43) Pub. Date: Dec. 27, 2012

(54) MULTI-FUNCTION TABLET COMPUTER GRIP WITH 360-DEGREE ROTATING FINGER RINGLET

(76) Inventors: Michael L. Solow, Dallas, TX (US); Robert J. DiFonzo, Dallas, TX (US)

(21) Appl. No.: 13/527,897

(22) Filed: Jun. 20, 2012

Related U.S. Application Data
(60) Provisional application No. 61/501,723, filed on Jun. 27, 2011.

(51) Int. Cl. F16M 11/12

(52) U.S. Cl. 248/688

(57) ABSTRACT

A multi-function, 360-degree rotating computer tablet grip is described that allows users to hold and manipulate a tablet computer with one hand. The tablet grip including rubberized pressure grips or contact points on each end to secure the back plate of the grip to a tablet computer. The back plate of the grip includes a 360-degree rotating disc with a flip-up ringlet through which the user's fingers are inserted positioned to allow the user to grip and control the tablet. Additionally, a kickstand is attached to the rear of back plate by a hinge attachment on one side.

### CROSS REFERENCE TO RELATED INFORMATION

This application claims the benefit of U.S. Provisional Application Ser. No. 61/501,723 filed Jun. 27, 2011 titled MULTI-FUNCTION TABLET COMPUTER GRIP WITH 360-DEGREE ROTATING FINGER RINGLET.

### TECHNICAL FIELD

The present invention is directed to the field of computer accessories for tablet computers, more particularly to an accessory for a tablet computer that allows the user to more easily hold and manipulate the tablet.

### BACKGROUND OF THE INVENTION

Tablet computers are wonderful devices. They have proved to have immense functionality for both work and play. One downside to their functionality, however, is that currently, tablet computers such as the iPad are not easily manipulated or controlled while in use. Due to their sleek design and low profile, the devices themselves do not presently have a handle or other means of maintaining security or stability while not decreasing the functionality of the device. The result is a high probability of the user to drop the tablet computer or employ an uncomfortable and non-ergonomic body orientation in an effort to use said tablet computer.

This is particularly apparent in circumstances where the tablet is being used to aid or assist in other tasks, such as where it is being used as an interface by speaker while a presentation is being given, or it is being used as a data entry device by a nurse, salesperson, or the like. Trying to hold the tablet with one hand while using it with the other is very difficult due to the size and design of current tablets. What is needed is a more secure and convenient way to hold the tablet with one hand while simultaneously using it with the other without fear of dropping the device.

### BRIEF SUMMARY OF THE INVENTION

In an embodiment, a grip to allow a user to hold a tablet computer is described. The grip includes a back plate mounted to the back of the tablet computer. A disk is attached to the back plate by a pivot, such that the disk can spin relative to the back plate, and a ringlet attached to the disk, the ringlet sized to accept one or more fingers of the user.

In another embodiment a tablet computer accessory is described that allows a user to grip the tablet computer. The accessory includes a back plate mounted to the back of the tablet computer, a stand element pivotably attached to back plate at one end of the stand element such that the opposite end can be extended away from the back plate to form a leg, a disk rotatably mounted to the back plate, and a ringlet pivotably mounted to the disk, the ringlet movable between a closed position and an open position. The ringlet is sized to accept one or more fingers of the user to allow the user to grip the tablet computer with a single hand.

In yet another embodiment, a tablet computer accessory allowing a user to grip the tablet computer is described. The accessory includes a back plate mounted to the back of the tablet computer, the back plate including a top grip receptacle and a bottom grip receptacle where friction grips are mounted in each of the top grip receptacle and the bottom grip receptacle, and each friction grip is made from a pliable material and forming a channel to accept an edge of the tablet computer. A stand element is pivotably attached to back plate at one end of the stand element such that the opposite end can be extended away from the back plate to form a leg, the stand element including an aperture. A disk is rotatably mounted to the back plate and accessible through the aperture in the stand plate when the stand plate is closed against the back plate, and a ringlet is pivotably mounted to the disk. The ringlet is movable between a closed position and an open position, and sized to accept one or more fingers of the user to allow the user to grip the tablet computer with a single hand. When the ringlet is in a fully open position, it may be used as a stand for the tablet computer.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of a preferred embodiment of a tablet grip according to the concepts described herein;

FIGS. 2A, 2B and 2C are additional perspective views of the tablet grip from FIG. 1;

FIG. 3 is an exploded perspective view of the tablet grip of FIG. 1 showing the components of a preferred embodiment of the tablet grip;

FIG. 4A is a front view of an embodiment of the stand plate from FIG. 3;

FIG. 4B is a side cutaway of the stand plate from FIG. 4A along section A-A;

FIG. 4C is a perspective view of the stand plate from FIG. 4A;

FIG. 5A is a front view of an embodiment of the back plate from FIG. 3;

FIG. 5B is a side cutaway of the back plate from FIG. 5A along section A-A;

FIG. 5C is a perspective view of the back plate from FIG. 5A;

FIG. 6A is a front view of an embodiment of the disk holder from FIG. 3;

FIG. 6B is a side cutaway of the disk holder from FIG. 6A along section A-A;

FIG. 6C is a perspective view of the disk holder from FIG. 6A;

FIG. 7A is a front view of an embodiment of the ringlet from FIG. 3;

FIG. 7B is a side cutaway of the ringlet from FIG. 7A along section A-A;

FIG. 7C is a perspective view of the ringlet from FIG. 7A;

FIG. 8A is a front view of an embodiment of the ringlet insert from FIG. 3;

FIG. 8B is a cutaway of the ringlet insert from FIG. 8A along section A-A;

FIG. 8C is a perspective view of the ringlet insert from FIG. 8A;

FIGS. 8D and 8E are a front view and a perspective view, respectively of the ringlet insert and ringlet combination;

FIG. 9A is a front view of an embodiment of the grip from FIG. 3;

FIG. 9B is a cutaway of the grip from FIG. 9A along section A-A;

FIG. 9C is a perspective view of the grip from FIG. 9A; and

FIG. 10 is a block diagram of an embodiment of an electronics package that may be incorporated into the tablet grip of the present invention.

### DETAILED DESCRIPTION OF THE INVENTION

As described, while tablet computers are incredibly useful and enjoyable, manipulating the tablet can be cumbersome and difficult. Unlike a smart phone that can be held with one hand while user types, or interacts with the phone with the other hand, it is difficult to hold the tablet with one had while using it due to its dimensions. To assist users in holding and manipulating their tablet computers, the present invention describes embodiments of a tablet grip that places a swiveling ringlet on the back of the tablet that can be used to hold and manipulate it. A user may insert two or three fingers through the ringlet to securely hold the tablet while using or manipulating the tablet with the other hand. In addition to the ringlet, embodiments of the tablet grip can also include one or more stand elements that allow the tablet to be placed into an upright position on a table, desk or other surface.

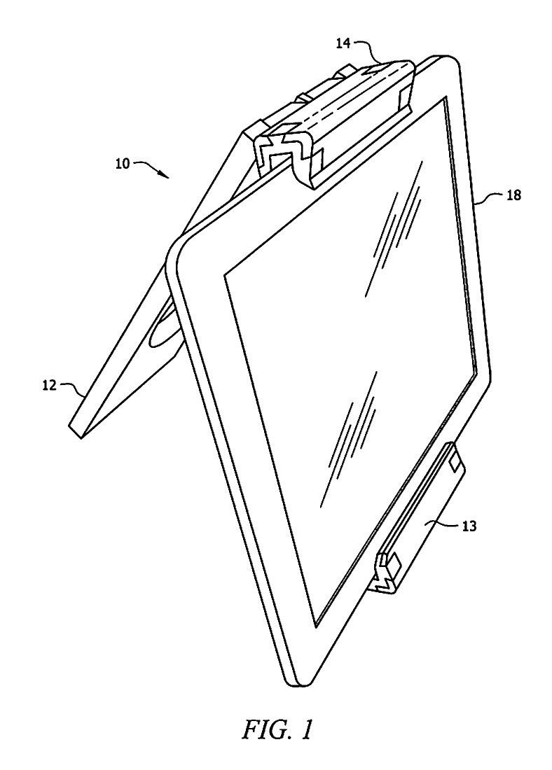

Referring now to FIG. 1, a preferred embodiment of a tablet grip according to the concepts described herein is shown. Tablet grip 10 includes pliable pressure grips 13 and 14 spaced to conform to a dimension of the tablet computer 18, shown here as spaced across the short or horizontal dimension of tablet 18. Preferred embodiments of tablet grip 10 may also include one or more stand elements 12 that can be extended to hold tablet 18 in an upright position for easy viewing by the user.

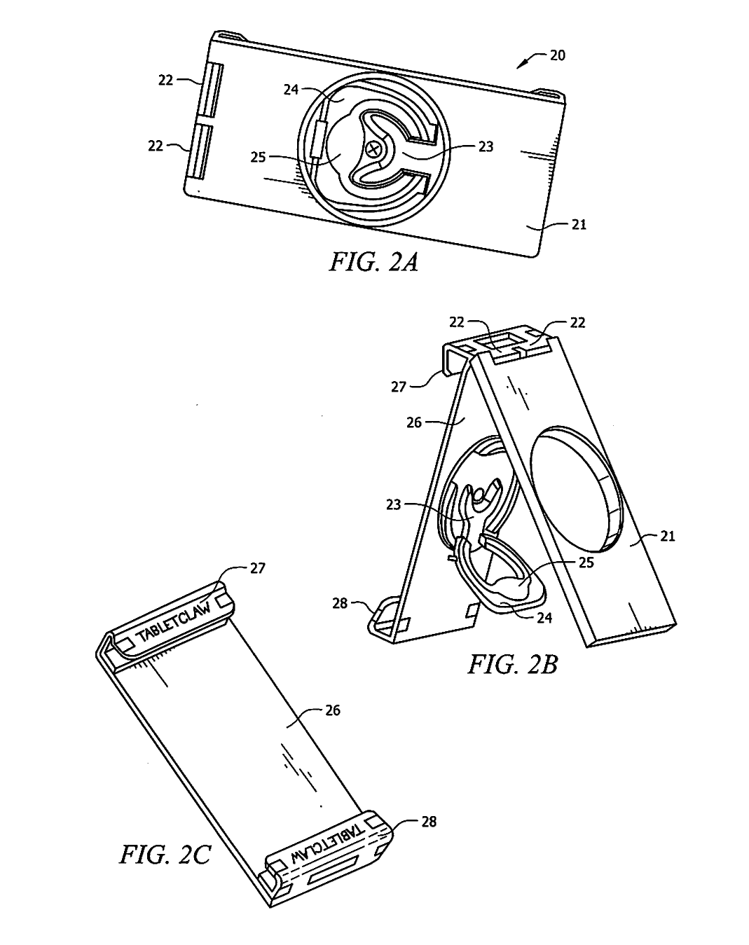

Referring now to FIGS. 2A through 2C, a preferred embodiment of the tablet grip from FIG. 1 is shown in more detail without the tablet computer. Tablet grip 20 includes back plate 26 which attaches to top grip 27 and bottom grip 28. As shown in FIG. 1, back plate 26 spaces top grip 27 and bottom grip 28 apart at the appropriate dimension to accommodate either the horizontal or vertical dimension of the tablet. The tablet then slides into the grips, which are formed from a pliable material that is compressed by the tablet. As the channel of each grip is slightly smaller than the depth of the tablet, the tablet is held in the grip by the friction existing between the grip and the tablet computer.

Attached to back plate 26 on the side opposite the tablet, is holder disk 23. Holder disk 23 is attached to back plate 26 using a screw and sleeve, described hereafter, that are designed to allow holder disk 23 to spin relative to back plate 26. Ringlet 24 is attached to back plate 26 along a hinge element on or near a lateral edge of holder disk 23. The hinge element allows ringlet 24 to move between a closed position flat against holder disk 23 (see FIG. 2A) and an extended position that is in a relatively perpendicular position to holder disk 23 (see FIG. 2B). Ringlet insert 25 is inserted into, or formed integrally with, ringlet 24 and is formed from pliable material to provide a comfortable contact point with the user's fingers.

In preferred modes of operation using the ringlet 24, the ringlet is extended from its closed position and stand element 21 is fully closed against back plate 26. Two fingers, such as the index and middle fingers of the users hand are inserted into ringlet 24 and comfortably contact ringlet insert 25. The user's thumb and ring and little finger are then placed flat against the back of the tablet. In this manner, the tablet is firmly held in the user's hand allowing the user to use and manipulate the table with the other had without fear of dropping the tablet. In addition, because the holder disk 23 is rotatably attached to the back plate 26, the user may spin the tablet in their hand without letting go of ringlet 24, allowing the user to transition the tablet from a portrait to a landscape orientation or to spin the tablet to show it to others in the area.

In preferred embodiments, tablet grip 20 also includes a stand element such as stand plate 21. Stand plate 21 connects to back plate 26 along hinge elements 22 on the top side of back plate 26. Hinge elements 22 allow stand plate 21 to move between a closed position flat against back plate 26 (see FIG. 2A) and an extended position that forms an angle relative to back plate 26 (see FIG. 2B). The tablet grip 20 can be made to accommodate any chosen angle when extended, but is preferably between 30 and 75 degrees relative to back plate 26. In its extended position, stand plate 21 can be used to orient the table computer in an upright position on a table or other surface, as shown in FIG. 1.

In preferred embodiments, ringlet 24 can also be used as a secondary stand element. When stand element 21 is closed and ringlet 24 is in its extended position, tablet can be placed on a surface such that the outer flat edge of ringlet 24 acts as a stand element, orienting the tablet in a “propped up” perpendicular position instead of the more vertical orientation achieved with the stand element 21.

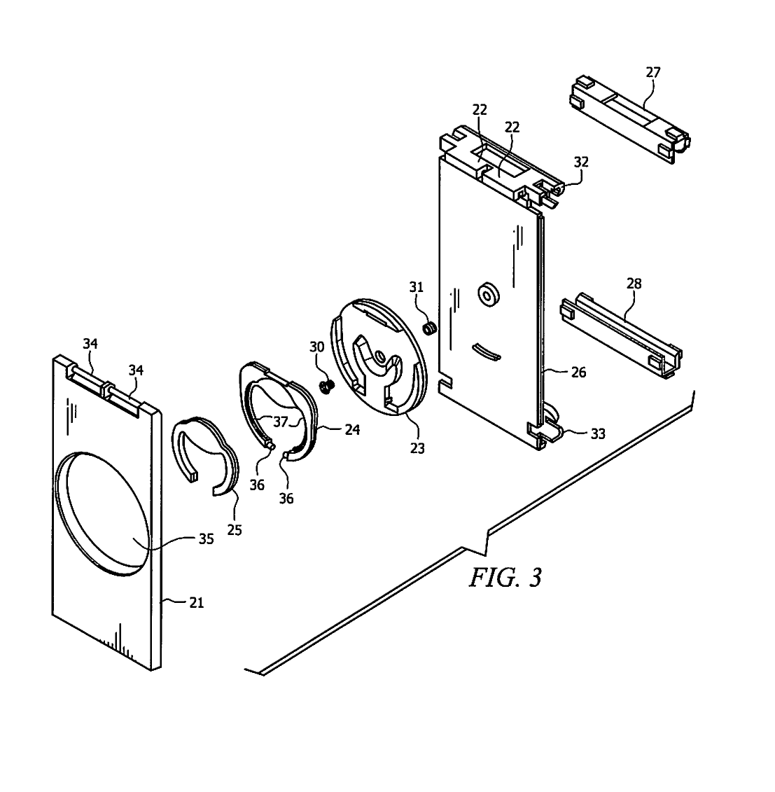

Referring now to FIG. 3, the embodiment of tablet grip 20 from FIGS. 2A through 2C is shown exploded into its individual elements. As described above, back plate 26 includes hinge elements 22 oriented toward the rear of back plate 26 (away from an installed tablet) for receiving hinge pins 34. Back plate 26 also includes integrally formed top grip holder 32 and bottom grip holder 33, which receive pliable top grip 27 and bottom grip 28 respectively. Stand plate 21 attaches to back plate 26 by inserting hinge pins 34 into hinge elements 22. Once inserted, stand plate 21 can then pivot along the hinge pins relative to back plate 26. Stand plate 21 also includes aperture 35 which allows the rotating assembly formed by holder disk 23 and ringlet 24 to extend through stand plate 21 when stand plate 21 is closed against back plate 26.

Holder disk 23 is rotatably mounted to back plate 26 using sleeve 31, which acts as a friction reducing bearing, and screw 30. Screw 30 attaches to back plate 26 using threads formed in back plate 26. Ringlet 24 then snaps onto disk holder 23 using pins 36 in the terminal ends of ringlet arms 37. Ringlet insert 25 fits into the interior of ringlet 24 to provide a comfortable contact point for the user's fingers.

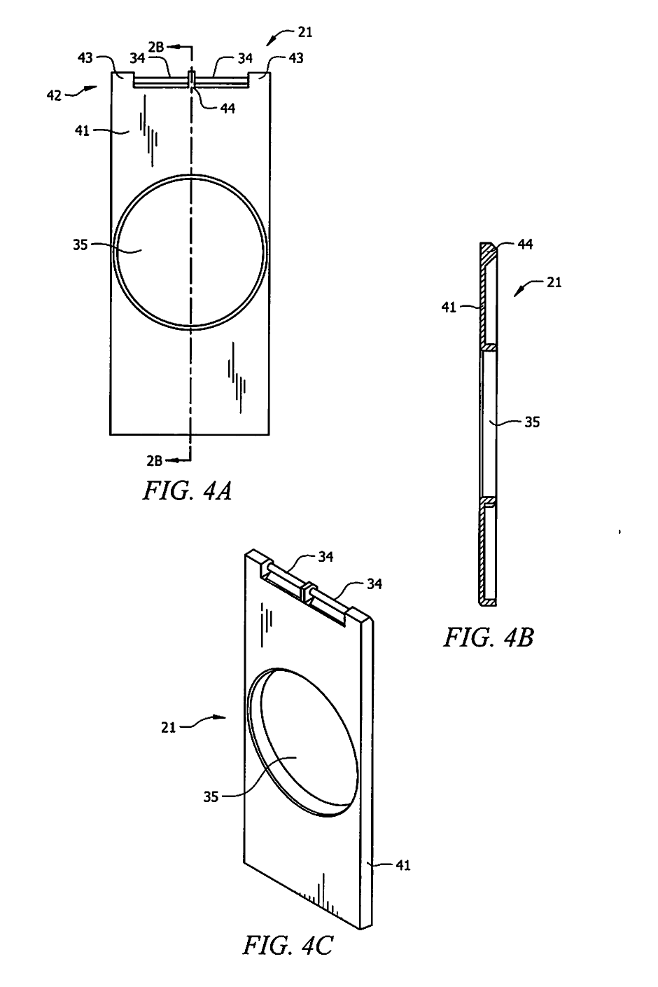

Referring now to FIGS. 4A, 4B and 4C, an embodiment of stand plate 21 from FIG. 3 is shown in greater detail. Stand plate 21 is preferably formed of a rigid molded plastic, such as an ABS polycarbonate blend, but can be formed of any suitable material, such as other types of plastics or metals. Stand plate 21 includes body 41 in which aperture 35 is formed. The top end 42 of stand element 21 includes integrally formed hinge pins 34 mounted between outer pin supports 43 and inner pin support 44.

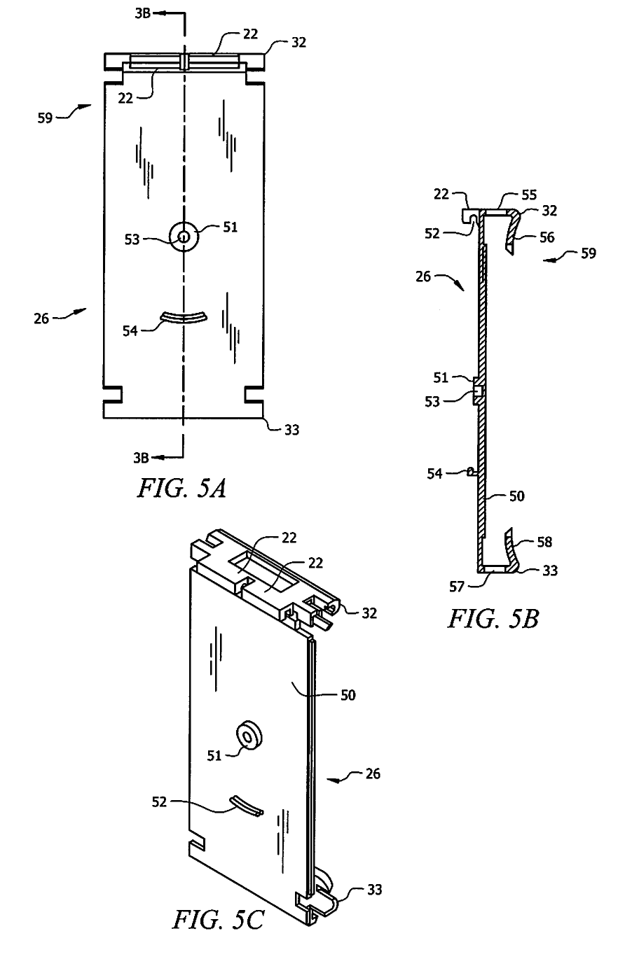

Referring now to FIGS. 5A, 5B, and 5C, an embodiment of a back plate 26 from FIG. 3 is shown in greater detail. Back plate 26 includes main body 50 which is integrally formed with top grip holder 32 and bottom grip holder 33 as well as hinge elements 22. Each of top grip holder 32 and bottom grip holder 33 is formed by a support element 55 and 57, respectively, and a retainer element 56 and 58, respectively. Retainer elements can be formed to apply a desired amount of spring tension when the grip element is inserted and a tablet is installed. The spring tension increases the friction between the grip element and the tablet and enhances retention of the tablet in the tablet grip. Each hinge element 22 includes a pin groove 52 which accepts the hinge pins on stand element 21, shown in FIG. 4.

The back, or non tablet facing side of body 50 includes elements to attach with and align holder disk 23. Projection 51 is conically shaped and extends outward from the face of body 50 a small amount. The purpose of projection 51 is to space holder disk 23 away from the surface of body 50 to reduce the friction between holder disk 23 and body 50 when holder disk 23 spins relative to body 50. Screwy thread 53 accepts screw 30 from FIG. 3 to securely attach holder disk 23 to back plate 26. Alignment ridge 54 is integrally formed with body 50 and is spaced from projection 51 by an amount equal to the radius of holder disk 23. Alignment ridge assists in the installation of holder disk 23 during manufacturing and can also provide a tactile indication of the orientation of the tablet in tablet grip 20 to the user.

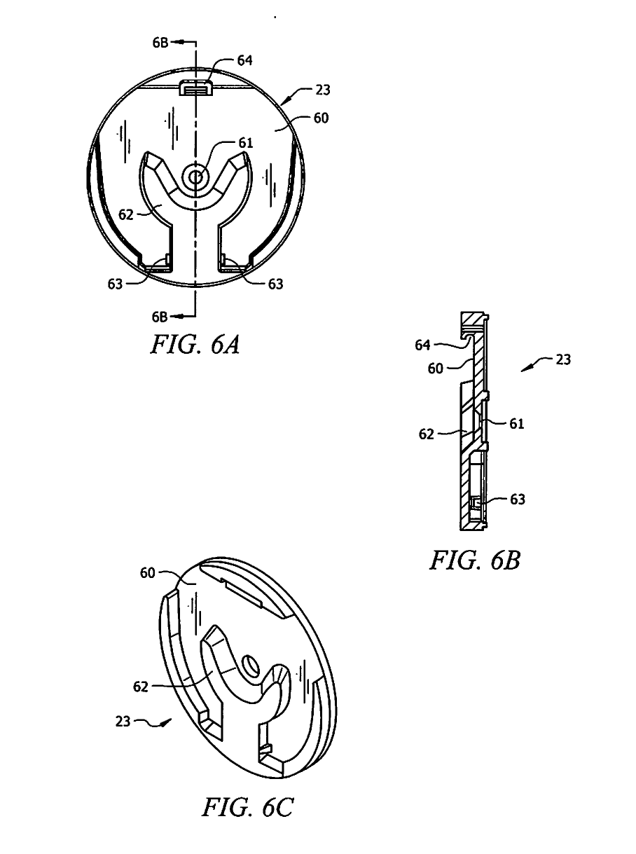

Referring now to FIGS. 6A, 6B, and 6C, an embodiment of a holder disk 23 from FIG. 3 is shown in greater detail. Holder disk 23 provides two functions to the tablet grip. First, it provides the axis on which the tablet grip can spin through 360-degrees in a user's hand, and second it provides the attachment point for the ringlet used to secure the tablet in the user's hand. Holder disk 23 is attached to back plate 26 using sleeve aperture 61 through which the sleeve 31 and screw 30 from FIG. 3 pass. Holder disk may then freely spin around the axis provided by the screw and sleeve relative to the back plate.

Recess portion 60, which is generally formed in the same shape as ringlet 24 from FIG. 3, provides space for ringlet 24 to be stored flush with the raised portion 62 of disk holder 23 when the ringlet is in its closed position. Ringlet 24 is attached to disk holder 24 by inserting ringlet pins 36 on ringlet 24 into ringlet pin holes 63. When installed, ringlet 24 can pivot along the axis formed by ringlet pin holes 63 between the closed position flush with the disk holder 23 and an open position extending away from disk holder 23. Latch 64 engages the end of ringlet 24 opposite the pivot point and can hold the ringlet in the closed position through a snap in place friction fit.

In addition to attaching a ringlet to disk holder 23, other types of mechanical interfaces can be attached to disk holder 23. Ringlet 24 could be detached by separating the ringlet pins from the ringlet pin holes 63 and other mechanical interfaces with pins could be inserted to allow the tablet grip to be employed in other scenarios. Examples of other mechanical interfaces would be wall mount attachments, car seat attachments or other similar applications.

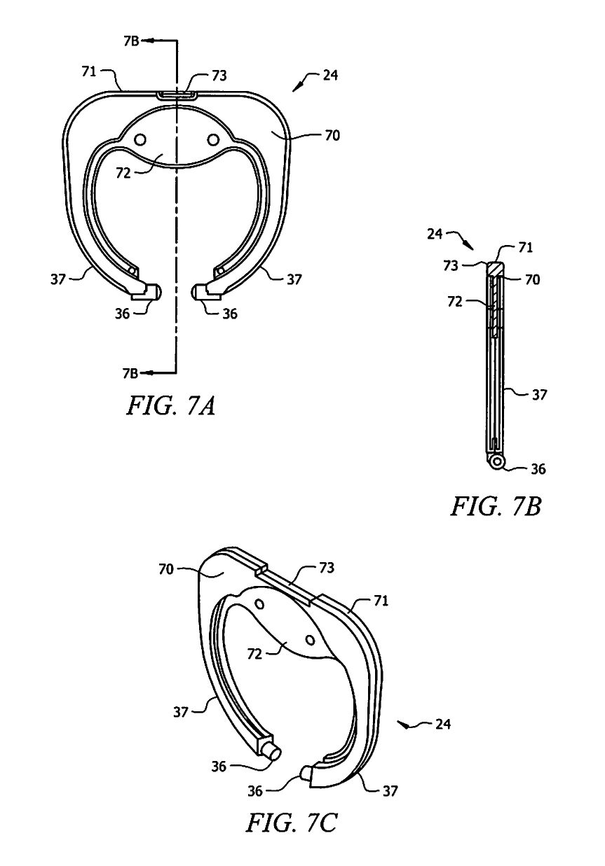

Referring now to FIGS. 7A, 7B, and 7C, an embodiment of a ringlet 24 from FIG. 3 is shown in greater detail. As described above, ringlet 24 pivotably attaches to holder disk 23. Ringlet 24 is formed by body 70 with integrally formed ringlet arms 37. At the end of each ringlet arm 37 ringlet pins 36 extend and are inserted into ringlet pin holes 63 in disk holder 23. Body 70 includes grip indent 72 which is sized and shaped to accept ringlet insert 25 from FIG. 3 through a fiction fit. Body 70 also includes a flat edge 71 along the edge of ringlet 23 opposite ringlet pins 36. As described above, flat edge 71 can be used to allow the ringlet 24 to operate as a secondary stand element for the tablet grip. In the center of flat edge 71 is latch indent 73 which is operable to engage with latch 64 on holder disk 23.

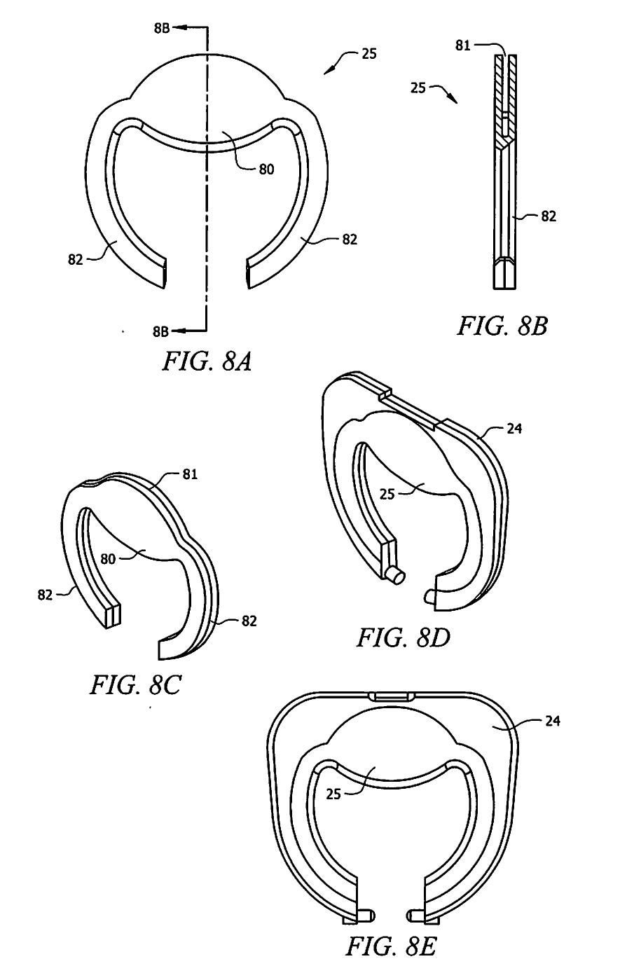

Referring now to FIGS. 8A, 8B, and 8C, an embodiment of a ringlet insert 25 from FIG. 3 is shown in greater detail. Ringlet insert is either overmolded or friction fit onto ringlet 24 to provide a pliable, higher-friction, more comfortable contact point between the user's fingers and the tablet grip. Ringlet insert is preferably formed using a pliable material such as a thermoplastic elastomer, though any suitable material with the desired properties could be used including other soft plastics, silicones, or rubber materials. Ringlet insert 25 is formed by body 80 having arms 82 and is shaped to fit the insert indent 72 in the ringlet. Insert indent 72 inserts into channel 81 in body 80 of ringlet insert 25 to hold ringlet insert in the correct position on ringlet 24. FIGS. 8D and 8E show ringlet insert 25 installed on ringlet 24.

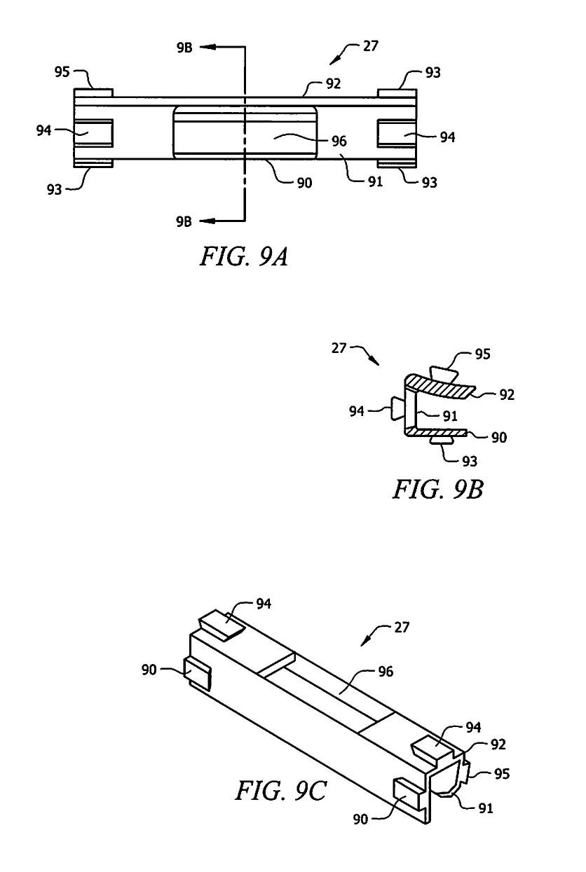

Referring now to FIGS. 9A, 9B, and 9C, an embodiment of a grip usable as top grip 27 or bottom grip 28 from FIG. 3 is shown in greater detail. Grip 27 is formed from material the same as or similar to ringlet insert 25. Grip 27 is preferably formed using a pliable material such as a thermoplastic elastomer, though any suitable material with the desired properties could be used including other soft plastics, silicones, or rubber materials. Grip 27 is preferably integrally formed with base 91, back arm 90 and retention arm 92. Back tabs 93, base tabs 94 and retention tabs 95 are integrally formed with grip 27 and fit into respective recesses within the grip holder 32 or 33 on back plate 26 to securely hold grip 27 to the appropriate grip holder. Grip 27 also includes recess 96 formed in base 91.

Grips can be formed to accommodate various tablets with differing thicknesses without having to change the overall dimensions of base plate 26. For thinner tablets a grip having a thicker base arm and/or retention arm can be made and inserted into the appropriate grip holder. For thicker tablets, a grip with a thinner base arm and/or retention arm can be used.

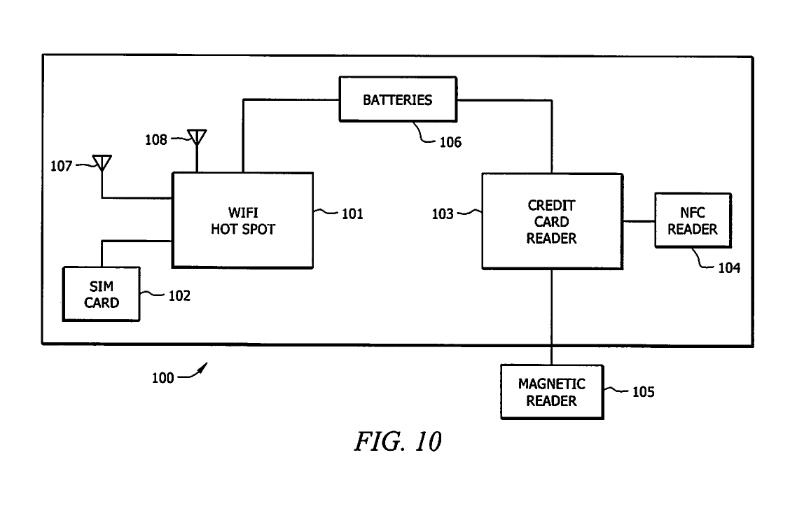

Referring now to FIG. 10, an embodiment of an electronics package for a tablet grip according to the concepts described herein is shown. Any tablet grip according to the concepts described herein, in addition to the mechanical features described, can incorporate electronics that would be useful to a tablet computer. An example of an embodiment of such electronics is shown by electronics package 100. Electronics package 100 includes a WiFi hotspot 101 such as is well known. The WiFi hotspot includes a cellular antenna 107 to communicate with a cellular network and a WiFi antenna 108 to broadcast and receive WiFi signals. A SIM card 102 is used to provide authentication to the cellular network. The electronics package may also include other features such as a credit card reader and processor 103 which may operate independently from or in conjunction with the WiFi hotspot 101. The credit card reader 103 can receive credit card information from an external or integrated magnetic strip reader 105 or from an NFC credit card reader 104. Replaceable or rechargeable batteries 106 provide power to the electronics. Other electronic modules may also be included into the tablet grip as appropriate.

The electronics package itself is preferably enclosed in one of the tablet grip components such as the back plate 26 or stand plate 21. The appropriate ports, such as a slot for a SIM card or connectors for connecting the electronics with external components would be provided into the tablet grip component.

The tablet grip can also include other features that are well within the scope of the concepts described herein. Compartments can be molded into various components to allow for the storage of other tablet accessories. The compartments can be general compartments or can be made specifically for certain items. Examples of accessories that could have storage compartments in the back plate or stand plate of the tablet grip are styluses, ear buds, screen cleaners, etc. Instead of compartments, clips mounted on the tablet grip could also be employed to hold tablet accessories securely to the tablet grip.

While components, other than the grips and ringlet insert are preferably formed from rigid materials such as polycarbonate plastic or aluminum, or combinations thereof, those rigid materials can be partially or completely coated with rubber or silicone to discourage damage to the tablet computer or any surface or furniture the tablet grip may come in contact with.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A grip to allow a user to hold a tablet computer comprising:
a back plate mounted to the back of the tablet computer;
a disk attached to the back plate by a pivot, such that the disk can spin relative to the back plate; and
a ringlet attached to the disk, the ringlet sized to accept one or more fingers of the user.

2. The grip of claim 1 further comprising a stand element, the stand element attached to the back plate at a top end of the stand element and back plate such that the bottom end of the stand may be extended away from the back plate and form a leg that may be used to stand the table computer on a surface.

3. The grip of claim 1 wherein the ringlet is operable to pivot along an axis along an edge of the disk such that the ringlet may transition between an open and closed position.

4. The grip of claim 1 wherein the ringlet in the open position may be used as a stand for the tablet computer.

5. The grip of claim 1 wherein the back plate mounts to the back of the tablet computer using a pair of friction grips at opposite edges of the tablet computer, each of the pair of grips having a channel that securely holds an edge of the tablet computer.

6. The grip of claim 1 further comprising an electronic component mounted in the grip.

7. The grip of claim 6 wherein the electronic component is a WiFi hotspot.

8. The grip of claim 6 wherein the electronic component is a credit card reader.

9. The grip of claim 1 further comprising a compartment to store accessories for the tablet computer.

10. The grip of claim 1 further comprising one or more clips to hold accessories for the tablet computer.

11. The grip of claim 1 wherein the ringlet is rotatable through 360 degrees.

12. A tablet computer accessory allowing a user to grip the tablet computer, the accessory comprising:
a back plate mounted to the back of the tablet computer;
a stand element pivotably attached to back plate at one end of the stand element such that the opposite end can be extended away from the back plate to form a leg;
a disk rotatably mounted to the back plate; and
a ringlet pivotably mounted to the disk, the ringlet movable between a closed position and an open position, wherein the ringlet is sized to accept one or more fingers of the user to allow the user to grip the tablet computer with a single hand.

13. The grip of claim 12 wherein the ringlet is rotatable through 360 degrees.

14. The grip of claim 12 wherein the ringlet in a fully open position may be used as a stand for the tablet computer.

15. The grip of claim 12 wherein the back plate mounts to the back of the tablet computer using a pair of friction grips at opposite edges of the tablet computer, each of the pair of grips having a channel that securely holds an edge of the tablet computer.

16. The grip of claim 12 further comprising an electronic component mounted in the grip.

17. The grip of claim 16 wherein the electronic component is a WiFi hotspot.

18. The grip of claim 16 wherein the electronic component is a credit card reader.

19. The grip of claim 12 further comprising a compartment to store accessories for the tablet computer.

20. The grip of claim 12 further comprising one or more clips to hold accessories for the tablet computer.

21. A tablet computer accessory allowing a user to grip the tablet computer, the accessory comprising:
a back plate mounted to the back of the tablet computer, the back plate including a top grip receptacle and a bottom grip receptacle;
friction grips mounted in each of the top grip receptacle and the bottom grip receptacle, each friction grip made from a pliable material and forming a channel to accept an edge of the tablet computer;
a stand element pivotably attached to back plate at one end of the stand element such that the opposite end can be extended away from the back plate to form a leg, the stand element including an aperture;
a disk rotatably mounted to the back plate and accessible through the aperture in the stand plate when the stand plate is closed against the back plate; and
a ringlet pivotably mounted to the disk, the ringlet movable between a closed position and an open position, wherein the ringlet is sized to accept one or more fingers of the user to allow the user to grip the tablet computer with a single hand and wherein the ringlet in a fully open position may be used as a stand for the tablet computer.

22. The grip of claim 21 further comprising an electronic component mounted in the grip.

23. The grip of claim 22 wherein the electronic component is a WiFi hotspot.

24. The grip of claim 22 wherein the electronic component is a credit card reader.

25. The grip of claim 21 further comprising a compartment to store accessories for the tablet computer.

26. The grip of claim 21 further comprising one or more clips to hold accessories for the tablet computer.
